(19) United States
(12) Patent Application Publication
(10) Pub. No.: US 2013/0108736 A1
(43) Pub. Date: May 2, 2013

(54) METHOD FOR IMPROVING THE QUALITY OF BREAD, ETC.

(71) Applicants: Eisuke Ishihara, Tokyo (JP); Hisato Matsumoto, Tokyo (JP); Yuichi Sasaki, Osaka (JP); Nobuyoshi Sato, Tokyo (JP)

(72) Inventors: Eisuke Ishihara, Tokyo (JP); Hisato Matsumoto, Tokyo (JP); Yuichi Sasaki, Osaka (JP); Nobuyoshi Sato, Tokyo (JP)

(73) Assignee: ORIENTAL YEAST CO., LTD., Itabashi-ku, Tokyo (JP)

(21) Appl. No.: 13/697,032

(22) PCT Filed: May 12, 2011
(86) PCT No.: PCT/JP2011/060999

§ 371 Date: Dec. 18, 2012

(30) Foreign Application Priority Data
May 13, 2010 (JP) 2010-111513

(51) Int. Cl. A21D 8/04

(52) U.S. Cl. CPC A21D 8/042
USPC 426/18; 426/64

(57) ABSTRACT

[Object] To provide a method for improving the quality of at least one member selected from breads, noodles, and confectioneries so that a soft texture (softness) and a moist texture (a moisture retaining property) are imparted, and the member is less susceptible to retrograding or aging even after the elapse of a certain period of time after production (retrogradation or aging is suppressed or prevented), and also to provide an agent to be used in the method.

[Means for Resolution] A soft texture (softness) and a moist texture (a moisture retaining property) can be imparted to at least one member selected from breads, noodles, and confectioneries and retrograding or aging during storage after production can be suppressed or prevented by producing said member with the addition of four ingredients: a processed product of a seaweed belonging to the family Lessoniaceae of the order Laminariales; α-amylase; β-amylase; and a partially gelatinized starch to wheat flour and/or rice flour to be used as a main raw material.

### TECHNICAL FIELD

The present invention relates to a method for improving the quality of breads, noodles, confectioneries, etc. and also relates to a quality improving agent to be used in said method. More particularly, the present invention relates to a method for improving the quality with respect mainly to the taste and texture of foods containing wheat flour and/or rice flour as a main raw material such as breads, noodles, and confectioneries and also relates to a quality improving agent to be used in the method containing highly safe substances as active ingredients.

### BACKGROUND ART

As the preferences of consumers are diversified, a demand for a differentiated product has been increased also for foods containing wheat flour or rice flour as a main raw material such as breads, noodles, and confectioneries. In particular, in addition to the quality such as the taste and the texture, a demand for a “more natural” food has been also increased, and for example, in the case of breads, a product without using an emulsifying agent and so on has been demanded.

Recently, qualities demanded for particularly breads, noodles, and confectioneries are “softness (a soft texture)” and “a moisture retaining property (a moist texture)”, and these textures have been demanded not only to be exhibited immediately after production, but also to be maintained even after the elapse of a certain period of time after production. To be more specific, it has been demanded that not only breads and the like immediately after production have a soft texture and a moist texture, but also hardening or drying up due to retrogradation (aging: namely, conversion into β-form) during storage after production be suppressed or prevented.

The term “retrogradation (conversion into β-form)” as used herein refers to a phenomenon as follows: by adding water to a food containing wheat flour, rice flour, or the like as a main raw material, followed by heating, starch contained therein is swollen and the molecular structure thereof is disrupted and the starch is converted into a gelatinized state (gelatinization: namely, conversion into β-form), and when this gelatinized starch is cooled, water molecules are gradually released from the swollen starch and the starch molecules return to the original structure to some extent. This phenomenon is called retrogradation (aging: namely conversion into β-form). It is known that such a food is most susceptible to retrogradation when being stored at a temperature in a refrigeration temperature range (from 4 to 10° C.), however, such a food is also subjected to retrograding at a temperature in a normal temperature range (from 10 to 30° C.) in many cases, and for example, breads turn into hard and dry.

As a method for imparting a soft texture and a moist texture to breads, noodles, confectioneries, etc. and suppressing or preventing the retrogradation (aging) thereof, there has been conventionally proposed a method in which any of various ingredients is added as a quality improving agent to raw materials of a product. For example, a method using an egg powder (Patent document 1), a method using maltose, a peptide or an amino acid, and starch (Patent document 2), a method using a catechin, etc. and a fermented product of soybeans and sesame. (Patent document 3), a method using a complex of a fat or lipid and a protein (Patent document 4), a method using a thickening agent (Patent document 5), and the like have been disclosed. However, these methods are not sufficiently satisfactory from the viewpoint that a highly safe substance is used as an active ingredient and the impartment of a soft texture and a moist texture and the suppression or prevention of aging are achieved simultaneously.

### CITATION LIST

### Patent Documents

Patent Document 1: JP-A-2008-035811

Patent Document 2: JP-A-2008-000133

Patent Document 3: JP-A-2007-111043

Patent Document 4: JP-A-2006-288341

Patent Document 5: JP-A-2002-291396

### SUMMARY OF THE INVENTION

### Problems that the Invention is to Solve

An object of the present invention is to provide a method for improving the quality of at least one member selected from breads, noodles, and confectioneries wherein a soft texture (softness) and a moist texture (a moisture retaining property) are imparted to the member, and the member is less susceptible to aging even after the elapse of a certain period of time after production (aging is suppressed or prevented) by using highly safe substances as active ingredients, and another object thereof is to provide an agent to be used in said method.

### Means for Solving the Problems

In order to achieve the above objects, the present inventors made intensive studies and found that a soft texture (softness) and a moist texture (a moisture retaining property) can be imparted to at least one member selected from breads, noodles, and confectioneries and aging during storage after production can be suppressed or prevented, that is, the quality of the member is improved to sufficiently satisfactory in the field of this art by producing the member with the addition of four ingredients: a processed product of a seaweed belonging to the family Lessoniaceae of the order Laminariales; α-amylase; β-amylase; and a partially gelatinized starch to wheat flour and/or rice flour to be used as a main raw material, and thus completed the present invention.

That is, embodiments of the present invention are as follows.

(1) A method for improving the quality of at least one member selected from breads, noodles, and confectioneries containing wheat flour (particularly domestic wheat flour) and/or rice flour as a main raw material, characterized by producing the member with the addition of a processed product of a seaweed belonging to the family Lessoniaceae of the order Laminariales, α-amylase, β-amylase, and a partially gelatinized starch to wheat flour and/or rice flour to be used as a main raw material.

(2) The method according to (1), characterized in that the improvement of the quality is the impartment of a soft texture (softness) and/or a moist texture (a moisture retaining property) and the suppression or prevention of retrogradation (aging: namely conversion into n-form).

(3) The method according to (1) or (2), characterized in that the processed product of a seaweed is at least one member selected from a dry powder of a seaweed, a seaweed extract (an extract obtained by extraction with a solvent such as hot water, a concentrated product thereof, or the like) , and a dry powder of a seaweed extract (a spray-dried product, a lyophilized product, or the like).

(4) The method according to any one of (1) to (3), characterized in that the gelatinization degree of the partially gelatinized starch is from 30 to 90% (preferably from 50 to 80%, more preferably from 60 to 700).

(5) The method according to any one of (1) to (4), characterized in that the processed product of a seaweed belonging to the family Lessoniaceae of the order Laminariales, α-amylase, β-amylase, and partially gelatinized starch are added such that the total amount of these ingredients is from 0.5 to 3.0% (preferably from 1.0 to 2.0%) with respect to the amount of the wheat flour and/or rice flour to be used as a main raw material.

(6) An agent for improving the quality of at least one member selected from breads, noodles, and confectioneries containing wheat flour (particularly domestic wheat flour) and/or rice flour as a main raw material, characterized by comprising 3 to 33% (preferably 5 to 25%, more preferably 10 to 20%) of a processed product of a seaweed belonging to the family Lessoniaceae of the order Laminariales, 0.03 to 0.3% (preferably 0.05 to 0.2%) of α-amylase and β-amylase, and 30 to 95% (preferably 40 to 95%, more preferably 55 to 90%) of a partially gelatinized starch as active ingredients.

(7) The agent according to (6), characterized in that the agent imparts a soft texture and/or a moist texture to at least one member selected from breads, noodles, and confectioneries and suppresses or prevents the retrogradation thereof.

(8) The agent according to (6) or (7), characterized in that the processed product of a seaweed is at least one member selected from a dry powder of a seaweed, a seaweed extract, and a dry powder of a seaweed extract.

(9) The agent according to any one of (6) to (8), characterized in that the gelatinization degree of the partially gelatinized starch is from 30 to 90% (preferably from 50 to 80%, more preferably from 60 to 70%).

(10) The agent according to any one of (6) to (9), characterized in that the agent is added in an amount of from 0.5 to 3.0% (preferably from 1.0 to 2.0%) with respect to the amount of the wheat flour and/or rice flour to be used as a main raw material.

### Advantage of the Invention

According to the present invention, a soft texture (softness in Japanese, yawarakasa or soft-kan) and a moist texture (a moisture retaining property in Japanese, shittori-kan) can be imparted to at least one member selected from breads, noodles, and confectioneries containing wheat flour or rice flour as a main raw material and retrogradation (hardening or drying) during storage after production can be suppressed or prevented by adding only a quality improving agent comprising highly safe substances as active ingredients (particularly in the case of breads, without adding an emulsifying agent or the like). The present invention is particularly effective when being used in a food containing domestic wheat flour or rice flour as a main raw material. Further, according to the present invention, the improvement of the production yield of breads, noodles, and confectioneries containing wheat flour or rice flour as a main raw material and so on can be also achieved.

### BRIEF DESCRIPTION OF THE DRAWINGS

FIG. 1 shows the measurement data of the hardness of a crumb portion of a slice of bread measured using a rheometer when a slice of bread having a standard formulation (additive-free) and a slice of bread with the addition of 2% of the quality improving agent of the present invention (present inventive product) were stored for 1 day (D+1) and for 3 days (D+3) at a temperature in a normal temperature range after being baked.

FIG. 2 shows the measurement data of the hardness of a crumb portion of a slice of bread measured using a rheometer when a slice of bread having a standard formulation (additive-free), a slice of bread with the addition of 1% of the quality improving agent of the present invention (present inventive product) , a slice of bread with the addition of only 1% of a partially gelatinized starch (partially gelatinized starch), a slice of bread with the addition of only 1% of a seaweed extract (seaweed extract), and a slice of bread with the addition of only 1% of α-amylase and β-amylase (amylase) were stored for 1 day (D+1) and for 3 days (D+3) at a temperature in a normal temperature range after being baked, respectively.

### MODE FOR CARRYING OUT THE INVENTION

The present invention is directed to a method for improving the quality of at least one member selected from breads, noodles, and confectioneries containing wheat flour and/or rice flour as a main raw material. The targeted breads, noodles, and confectioneries are not particularly limited as long as they contain wheat flour or rice flour as a main raw material, and there is no problem even if they contain a material commonly used as an auxiliary raw material (for example, in the case of breads, yeast, a sugar, an oil or fat, a bread improver, a salt, an egg, a dairy product, etc.) . The term “main raw material” as used herein refers to a raw material contained in an amount of 60% or more (for example 70% or more, from 80 to 99%, etc.) of the amount of the raw materials excluding water. Incidentally, the present invention is particularly preferred for improving the quality of breads and confectioneries. Although when domestic wheat flour or rice flour is used, for example, in the case of breads, a product is susceptible to retrogradation and drying up in many cases, and the present invention is particularly effective in such a product.

In the present invention, a product is produced by adding a processed product of a seaweed belonging to the family Lessoniaceae of the order Laminariales, α-amylase, β-amylase, and a partially gelatinized starch to wheat flour and/or rice flour to be used as a main raw material. All of these ingredients are substances that have been eaten for a long time and are very highly safe. Further, in the case of breads and the like, it is not necessary to use an emulsifying agent in combination, and therefore, these ingredients meet the recent needs of a “more natural” product. These ingredients may be added separately and also may be added as a mixed agent containing the four ingredients (and other formulation ingredients, etc.).

As for the addition amount, in the case where the ingredients are used as a mixed agent, it is preferred that 3 to 33% (preferably 5 to 25%, more preferably 10 to 20%) of a processed product of a seaweed belonging to the family Lessoniaceae of the order Laminariales, 0.03 to 0.3% (preferably 0.05 to 0.2%) of α-amylase and β-amylase, and 30 to 95% (preferably 40 to 95%, more preferably 55 to 90%) of a partially gelatinized starch are mixed to form a mixed agent, and the resulting mixed agent is added in an amount of from 0.5 to 3.0% (preferably from 1.0 to 2.0%) with respect to the amount of wheat flour and/or rice flour to be used as a main raw material. Also in the case where the respective ingredients are added separately, the addition amount of each ingredient is set according to the above-described formulation amount of the mixed agent, and the respective ingredients may be added such that the combined amount (total amount) of these ingredients is from 0.5 to 3.0% (preferably from 1.0 to 2.0%) with respect to the amount of wheat flour and/or rice flour to be used as a main raw material.

The processed product of a seaweed to be used in the present invention is derived from a seaweed belonging to the family Lessoniaceae of the order Laminariales of the class Phaeophyceae. The processed product includes a dry powder obtained by drying a seaweed as such and grinding the dried seaweed, a seaweed extract obtained by extraction from a seaweed with hot water, an organic solvent, or the like, a concentrated product obtained by concentrating the seaweed extract, a spray-dried powder (a spray-dried product) thereof, a lyophilized ground product (a lyophilized product) thereof, and the like. The processed product of a seaweed not only has an activity of increasing the water absorption ratio of a product, but also has an activity of enhancing the dough processing ability of an amylase, and therefore, the quality improving agent of the present invention using an amylase in combination has a characteristic of exhibiting a synergistic effect.

The α-amylase and β-amylase to be used in the present invention are not particularly limited, and a commercially available amylase preparation or the like can be used. As for the origin of the amylase, any of a wide variety of types of amylases such as a microorganism-derived amylase or a plant-derived amylase can be used, however, the amylase preferably has an enzymatic activity of 30000 u/g or more. Incidentally, in the present invention, it is necessary to use α-amylase and β-amylase in combination, and the use of only one of α-amylase or β-amylase is not preferred because a sufficient effect of the present invention is not exhibited in such a case. Further, in either the case where the respective ingredients are added separately or the case where the respective ingredients are added as a mixed agent, in comparison with the amounts between α-amylase and β-amylase, the amount of β-amylase is preferably set to a value which is about 2 to 10 times higher than that of α-amylase.

As the partially gelatinized starch to be used in the present invention, a substance obtained by partially gelatinizing common starch physically can be used, and a commercially available product can be also used. The gelatinization degree thereof is not limited, however, it is preferred that the gelatinization degree thereof is from 30 to 90% (preferably from 50 to 80%, more preferably from 60 to 70%). Due to the activity of this partially gelatinized starch, particularly, the moist texture of a product can be enhanced.

After the quality improving agent is added to wheat flour and/or rice flour to be used as a main raw material, a product may be produced according to a common procedure for each product . In the present invention, a special production step or the like is not necessary except for adding the quality improving agent, and further, the quality improving agent can be used without any problem in a method for producing any product, and the use thereof is not particularly limited.

According to the present invention, the water absorption ratio of dough is dramatically increased (3 to 4 times that of the conventional dough), and the moist texture (water retention property) and the soft texture (softness) of breads or the like are significantly improved, and also the retrogradation thereof is significantly suppressed or prevented. Further, an additional effect is also exhibited, for example, in the case of noodles, a boiling time is reduced, and in the case of cakes, the occurrence of a crack is suppressed or prevented, and so on. Therefore, by the addition of the quality improving agent of the present invention, the quality of breads, noodles, confectioneries, and the like is improved to sufficiently satisfactory in the field of this art, and an additional benefit can be provided.

Hereinafter, Examples of the present invention will be described, however, the present invention is not limited only to these Examples.

### EXAMPLE 1

(Test for Validation of Effect of Addition to loaf of Bread Obtained Using 100% Domestic Wheat Flour)

In order to validate the effect of the addition of the quality improving agent of the present invention, the following test was carried out for loaf of breads obtained using 100% domestic wheat flour (in Japanese, kyoriki-ko) (strong flour (domestic wheat)).

Two types of loaf of breads having a standard formulation using 100% strong flour (domestic wheat): a control without the addition of the quality improving agent of the present invention (additive-free); and a product with the addition of 2% of the bread quality improving agent of the present invention (present inventive product) were produced by a sponge dough method (in Japanese, nakadane method). The formulations of the respective products are shown in Table 1, and the production conditions thereof are shown in Table 2. Incidentally, as a yeast, shortening, and a bread improver (in Japanese, yeast food), commercially available standard products for loaf of breads were used, and as the bread quality improving agent of the present invention, an agent prepared by forming a mixed agent containing a dry product of an extract obtained by extraction with hot water from a seaweed belonging to the family Lessoniaceae of the order Laminariales, commercially available α-amylase preparation and β-amylase preparation for use in foods, and a commercially available partially gelatinized cornstarch as active ingredients was used.

TABLE 1

| | | | Quality improving agent- | |
|---|---|---|---|---|
| | Control product | | added product (present | |
| | (additive-free) | | inventive product) | |
| | Sponge | Main | Sponge | Main |
| Formulation | dough | dough | dough | dough |
| Domestic wheat flour | 700 g | 300 g | 700 g | 300 g |
| Yeast | 22 g | | 22 g | |
| Sugar | | 60 g | | 60 g |
| Powdered skim milk | | 20 g | | 20 g |
| Salt | | 20 g | | 20 g |
| Shortening | | 50 g | | 50 g |
| Yeast food | 1 g | | 1 g | |
| Bread quality | | | | 20 g |
| improving agent | | | | |
| Water | 400 g | 280 g | 400 g | 340 g |

TABLE 2

| | | | Quality improving agent- | |
|---|---|---|---|---|
| | Control product | | added product (present | |
| | (additive-free) | | inventive product) | |
| | Sponge | Main | Sponge | Main |
| Step | dough | dough | dough | dough |
| Mixing speed and | L2M2 | L1M3↓M3H2 | L2M2 | L1M3↓M3H2 |
| time (min) | | | | |
| Dough temperature | 24° C. | 28° C. | 24° C. | 28° C. |
| after completion of | | | | |
| kneading | | | | |
| Fermentation | 28° C., | 28° C., | 28° C., | 28° C., |
| temperature and | 4 hours | 15 minutes | 4 hours | 15 minutes |
| time | | | | |
| Dividing weight | | 220 g × 6 | | 220 g × 6 |
| Bench time | | 17 minutes | | 17 minutes |
| Shaping | | Pullman pan | | Pullman pan |
| | | Dough specific | | Dough specific |
| | | volume: 4.2 | | volume: 4.2 |
| Final proofing time | | 45 minutes | | 45 minutes |
| (35° C., 85% RH) | | | | |
| Baking time | | 38 minutes | | 38 minutes |
| (210° C.) | | | | |

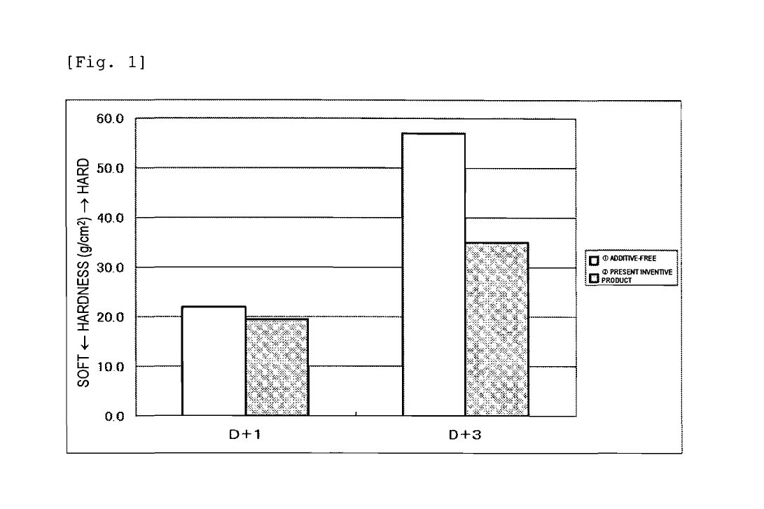

The obtained 2 types of loaf of breads were stored at a temperature in a normal temperature range after being baked, and after the elapse of 1 day and 3 days, the evaluation of the hardness of a crumb portion measured using a rheometer (NRJ-2002J, manufactured by Fudo Industry Co., Ltd.) (FIG. 1), and the measurement of a water absorption ratio, the measurement of a water content in a crumb portion, and a sensory evaluation (Table 3) were carried out according to common procedures. Incidentally, the evaluation of the hardness of a crumb portion was carried out as follows. The loaf of bread was sliced to a thickness of 2 cm, a center portion of the sliced bread was cut into a 5 cm square piece, the piece having a thickness of 2 cm was compressed to a thickness of 1 cm, and then, the hardness and resilience of the bread in such a compressed state were measured using a rheometer and evaluated.

As a result, the present inventive product had a higher water absorption ratio than the additive-free product, and after the elapse of 1 day after being baked, the present inventive product had a moister texture than the additive-free product, and was also significant in the sensory evaluation. After the elapse of 3 days after being baked, while the additive-free product rapidly became hard (retrograded: aged), a change in the hardness (retrogradation:aging) of the present inventive product progressed very gradually and also in the sensory evaluation, the present inventive product did not have a dry texture, and a moist texture was sufficiently maintained (FIG. 1 and Table 3).

TABLE 3

| | | Water content | | |
|---|---|---|---|---|
| | Water | in crumb | Texture | Texture |
| | absorption | portion | of bread | of bread |
| | ratio | (D + 1) | (D + 1) | (D + 3) |
| Additive- | 60% | 41.2% | Characteristic | Very dry |
| free | | | glutinous texture | texture |
| product | | | with slightly | |
| | | | dry texture | |
| Present | 65% | 43.7% | Moister texture | Moist texture |
| inventive | | | than additive- | without |
| product | | | free product | dry texture |

From the above results, it was shown that by using the novel bread quality improving agent of the present invention, a loaf of bread obtained using 100% domestic wheat flour having a favorable quality such that the bread has a soft texture and a moist texture, and such textures are maintained during storage, which was not achieved in conventional loaf of breads obtained using 100% domestic wheat flour, is obtained.

### EXAMPLE 2

(Test for Validation by Comparison with Addition of Each Ingredient Alone)

In order to validate the effect of the addition of the quality improving agent of the present invention by comparison with the effect of the addition of each ingredient alone, the following test was carried out for loaf of breads obtained using wheat flour (strong flour (imported wheat)).

As the wheat flour, strong flour (imported wheat) was used, and 5 types of breads: a control without the addition of the bread quality improving agent (additive-free); a product with the addition of 1% of the bread quality improving agent of the present invention (present inventive product); a product with the addition of only 1% of a partially gelatinized cornstarch (partially gelatinized starch); a product with the addition of only 1% of a seaweed extract (seaweed extract); and a product with the addition of only 1% of α-amylase and β-amylase (amylase) were produced by a sponge dough method. The formulations of the respective products are shown in Table 4, and as the production conditions, the same conditions shown in Table 2 of Example 1 were employed. Incidentally, as the respective ingredients and raw materials, the same ingredients and raw materials as in Example 1 were used.

TABLE 4

| | | | Present | | Partially | | | | | |
|---|---|---|---|---|---|---|---|---|---|---|
| | | | inventive | | gelatinized | | Seaweed | | | |
| | Additive-free | | product | | starch | | extract | | Amylase | |
| | Sponge | Main | Sponge | Main | Sponge | Main | Sponge | Main | Sponge | Main |
| Formulation | dough | dough | dough | dough | dough | dough | dough | dough | dough | dough |
| Wheat flour | 700 g | 300 g | 700 g | 300 g | 700 g | 300 g | 700 g | 300 g | 700 g | 300 g |
| Yeast | 22 g | | 22 g | | 22 g | | 22 g | | 22 g | |
| Sugar | | 60 g | | 60 g | | 60 g | | 60 g | | 60 g |
| Powdered skim | | 20 g | | 20 g | | 20 g | | 20 g | | 20 g |
| milk | | | | | | | | | | |
| Salt | | 20 g | | 20 g | | 20 g | | 20 g | | 20 g |
| Shortening | | 50 g | | 50 g | | 50 g | | 50 g | | 50 g |
| Yeast food | 1 g | | 1 g | | 1 g | | 1 g | | 1 g | |
| Bread quality | | | | 20 g | | | | | | |
| improving agent | | | | | | | | | | |
| Partially | | | | | | 20 g | | | | |
| gelatinized starch | | | | | | | | | | |
| Seaweed extract | | | | | | | | 20 g | | |
| Amylase | | | | | | | | | | 20 g |
| Water | 400 g | 280 g | 400 g | 340 g | 400 g | 310 g | 400 g | 310 g | 400 g | 280 g |

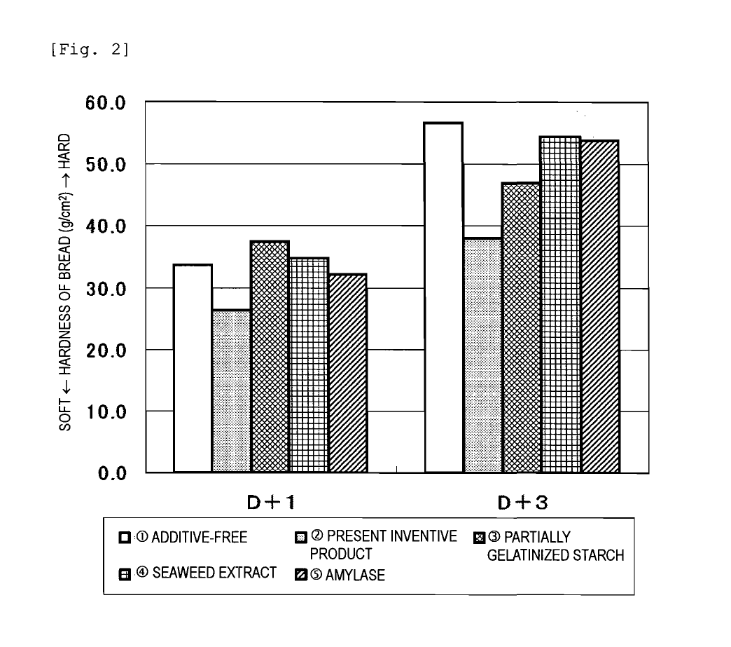

The obtained 5 types of loaf of breads were stored at a temperature in a normal temperature range after being baked, and after the elapse of 1 day and 3 days, the evaluation of the hardness of a crumb portion measured using a rheometer (NRJ-2002J, manufactured by Fudo Industry Co., Ltd.) (FIG. 2) was carried out, and after the elapse of 3 days, a sensory evaluation (Table 5) was carried out. Incidentally, the evaluation of the hardness of a crumb portion was carried out as follows. The loaf of bread was sliced to a thickness of 2 cm, a center portion of the sliced bread was cut into a 5 cm square piece, the piece having a thickness of 2 cm was compressed to a thickness of 1 cm, and then, the hardness and resilience of the bread in such a compressed state were measured using a rheometer and evaluated. Further, the sensory evaluation was carried out by 5 trained panelists on a score of 1 to 5 by giving the additive-free product a score of 3.0 and evaluating the other products in comparison with the additive-free product.

As a result, after the elapse of 1 day after being baked, the present inventive product had a softer texture than the additive-free product and the products with the addition of each ingredient alone, and it is apparent that the quality of the present inventive product was apparently significant. Further, a difference in the quality was not observed among the other 4 types of breads. After the elapse of 3 days after being baked, while the additive-free product rapidly became hard (retrograded: namely, aged), a change in the hardness (retrogradation: namely, aging) of the present inventive product progressed very gradually. The aging of the product with the addition of only the partially gelatinized starch also progressed somewhat gradually, however, the product was inferior to the present inventive product. As for the products with the addition of the seaweed extract or the amylase alone, a difference in the aging speed was not observed between the products and the additive-free product (FIG. 2).

Also in the sensory evaluation, the present inventive product was evaluated to have the softest texture as compared with the additive-free product, and shown to have a very favorable quality. Further, also in the sensory evaluation, the product with the addition of only the partially gelatinized starch was inferior to the present inventive product, and a significant difference was not observed between the products with the addition of the seaweed extract or the amylase alone and the additive-free product (Table 5).

TABLE 5

| | | Present | Partially | | |
|---|---|---|---|---|---|
| | Additive- | inventive | gelatinized | Seaweed | |
| Formulation | free | product | starch | extract | Amylase |
| Results of | 3.0 | 4.6 | 4.2 | 3.0 | 3.8 |
| sensory | | | | | |
| evaluation | | | | | |

1: hard, 2: somewhat hard, 3: equivalent, 4: somewhat soft, 5: soft

From the above results, it was shown that by using the novel quality improving agent of the present invention, a remarkable effect that a loaf of bread having a very soft texture and a moist texture and capable of maintaining the textures during storage is obtained, which was not achieved by conventional methods, is achieved.

In summary, the present invention is as follows.

An object of the present invention is to provide a method for improving the quality of at least one member selected from breads, noodles, and confectioneries so that a soft texture (softness) and a moist texture (a moisture retaining property) are imparted, and the member is less susceptible to retrograding or aging even after the elapse of a certain period of time after production (retrogradation or aging is suppressed or prevented) , and another object thereof is to provide an agent to be used in said method.

A soft texture (softness) and a moist texture (a moisture retaining property) can be imparted to at least one member selected from breads, noodles, and confectioneries and retrograding or aging during storage after production can be suppressed or prevented by producing said member with the addition of four ingredients: a processed product of a seaweed belonging to the family Lessoniaceae of the order Laminariales; α-amylase; β-amylase; and a partially gelatinized starch to wheat flour and/or rice flour to be used as a main raw material.

1. A method for improving the quality of at least one member selected from breads, noodles, and confectioneries, by producing the member with the addition of a processed product of a seaweed belonging to the family Lessoniaceae of the order Laminariales, α-amylase, β-amylase, and a partially gelatinized starch to wheat flour and/or rice flour to be used as a main raw material.

2. The method according to claim 1, wherein the improvement of the quality is the impartment of a soft texture and/or a moist texture and the suppression or prevention of retrogradation or aging.

3. The method according to claim 1, wherein the processed product of a seaweed is at least one member selected from a dry powder of a seaweed, a seaweed extract, and a dry powder of a seaweed extract.

4. The method according to claim 1, wherein the gelatinization degree of the partially gelatinized starch is from 30 to 90%.

5. The method according to claim 1, wherein the processed product of a seaweed belonging to the family Lessoniaceae of the order Laminariales, α-amylase, β-amylase, and partially gelatinized starch are added in an amount of from 0.5 to 3.0% with respect to the amount of the wheat flour and/or rice flour to be used as a main raw material.

6. An agent for improving the quality of at least one member selected from breads, noodles, and confectioneris, and containing 3 to 33% of a processed product of a seaweed belonging to the family Lessoniaceae of the order Laminariales, 0.03 to 0.3% of α-amylase and β-amylase, and 30 to 95% of a partially gelatinized starch as active ingredients.

7. The agent according to claim 6, wherein the agent imparts a soft texture and/or a moist texture to at least one member selected from breads, noodles, and confectioneries and suppresses or prevents the retrogradation thereof.

8. The agent according to claim 6, wherein the processed product of a seaweed is at least one member selected from a dry powder of a seaweed, a seaweed extract, and a dry powder of a seaweed extract.

9. The agent according to claim 6, wherein the gelatinization degree of the partially gelatinized starch is from 30 to 90%.

10. The agent according to claim 6, wherein the agent is added in an amount of from 0.5 to 3.0% with respect to the amount of the wheat flour and/or rice flour to be used as a main raw material.
